(19) United States
(12) Patent Application Publication
(10) Pub. No.: US 2011/0168934 A1
(43) Pub. Date: Jul. 14, 2011

(54) BALL VALVE FOR A TANK TRAILER

(76) Inventors: Greg Sisk, Farmington, MO (US); Dan Casey, Pilot Knob, MO (US); Roger Breakfield, Potosi, MO (US)

(21) Appl. No.: 12/987,574

(22) Filed: Jan. 10, 2011

Related U.S. Application Data
(60) Provisional application No. 61/335,754, filed on Jan. 11, 2010.

(51) Int. Cl. F16K 5/06

(52) U.S. Cl. 251/315.1

(57) ABSTRACT

A ball valve has a first half and second half coupled to form a valve body. The first half has an outlet passage, a single ball seat at an opening of the outlet, a first aperture receiving a first stem, and a first flange oriented about 45 degrees from the outlet. The second half has an inlet passage, a second aperture receiving a second stem, and a second flange oriented about 45 degrees from the inlet. A half ball is coupled to a first stem and a second stem disposed in the first and second apertures such that the half ball rotates about an axis of the first and second stems. The half ball rotates between a closed position in which a sealing side of the half ball is sealed against the single ball seat to prevent fluid flow, and an open position that permits fluid flow.

### CROSS-REFERENCE TO RELATED APPLICATIONS

This application claims the benefit of U.S. Provisional Application No. 61/335,754, filed on Jan. 11, 2010. The entire disclosure of the above application is incorporated herein by reference.

### FIELD

The present disclosure relates to a ball valve and, more particularly, an improved ball valve for a tank trailer.

### BACKGROUND

This section provides background information related to the present disclosure which is not necessarily prior art.

Ball valves are commonly used in conjunction with aeration equipment on tanker trucks to provide a sealable opening for the air that aids the unloading of material stored in the tanker. For example, some tankers are used to transport plastic pellets used in the molding and extrusion industries. Air is supplied to a trailer via ball valves that feed specialized equipment for introducing airflow and vibrations to assist in the unloading of the material in the trailer.

Moreover, known ball valves such as that disclosed in U.S. Pat. No. 2,751,185, are typically formed from several pieces. For example, hose barbs are typically added to the valve as a separate piece. Thus, additional seals are required for the hose barbs. Known ball valves are also formed as a full ball having a ball stem made from an addition piece of material. The full ball configuration further requires the addition of a second ball seat in the valve. Additionally, the additional pieces add to the manufacturing time and cost; wear on the valve, for example stretching, gaffing, and cracking of the ball stem; and repair time and costs. Moreover, the overall weight of the ball valve is increased thereby increasing equipment damage and fuel consumption of the tanker.

### SUMMARY

This section provides a general summary of the disclosure, and is not a comprehensive disclosure of its full scope or all of its features.

According to one aspect of the present disclosure, a ball valve design is provided that includes fewer parts, thereby eliminating the costs and time associated with manufacturing and repairing the ball valve. The ball valve design also provides a valve that requires less torque to operate and is susceptible to less wear than existing ball valves.

In one embodiment, a ball valve is provided that includes a valve body that forms a cavity. An inlet and an outlet are in fluid communication with the cavity. A half ball positioned within the cavity includes a concave recess to form a fluid passage through the half ball in an open position, to control flow through the cavity. When the half ball is rotated to a closed position, the half ball seals against a single ball seat at the outlet to prevent the flow of fluid through the cavity. When the half ball is rotated to an open position, the recess enables fluid flow through the cavity.

In another embodiment, a ball valve is provided having a valve body forming a cavity. The valve body includes a first half and a second half coupled together to form the cavity. An outlet passage and/or hose barb is integrally formed with the first half, and an inlet passage and/or hose barb is integrally formed with the second half. The inlet and the outlet are in fluid communication with the cavity. The first half includes a first flange formed at an approximately forty-five degree angle from the outlet passage, and the second half includes a second flange formed at an approximately forty-five degree angle from the inlet passage. The first flange and the second flange are coupled to connect the first half and the second half of the valve body.

In yet another embodiment, a ball valve is provided that includes a first half of a valve body and a second half of a valve body coupled together to form a cavity therein. The first half of the valve body has an outlet passage, a single ball seat positioned at an opening of the outlet passage, a first aperture through which a first stem is received, and a first flange oriented at approximately 45 degrees from the axis of the outlet passage. The second half of the valve body has an inlet passage, a second aperture through which a second stem is received, and a second flange oriented at approximately 45 degrees from the axis of the inlet passage. A half ball is coupled to a first stem disposed in the first aperture and to a second stem disposed in the second aperture such that the half ball rotates about an axis of the first stem and second stem. The half ball has a ball-shaped sealing side configured to sealingly engage the single ball seat, and a recessed side opposite a ball-shaped sealing side. The half ball is configured to rotate between a closed position in which the sealing side is sealed against the single ball seat to prevent fluid flow though the ball valve, and an open position in which the recess forms a passage from the inlet to the outlet to permit fluid flow therethrough. A handle is coupled to the first stem to rotate the half ball between the closed position and open position to control flow through the ball valve

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view one embodiment of a ball valve in accordance with the present disclosure:

FIG. 2 is a top view of the ball valve shown in FIG. 1;

FIG. 3 is a side view of the ball valve shown in FIG. 1;

FIG. 4 is a front view of the ball valve shown in FIG. 1;

FIG. 5 is a cross-sectional view of the ball valve shown in FIG. 4 taken along line 5 shown in FIG. 4, wherein the ball valve is in a closed position; and

FIG. 6 is a cross-sectional view of the ball valve shown in FIG. 5, wherein the ball valve is in an open position.

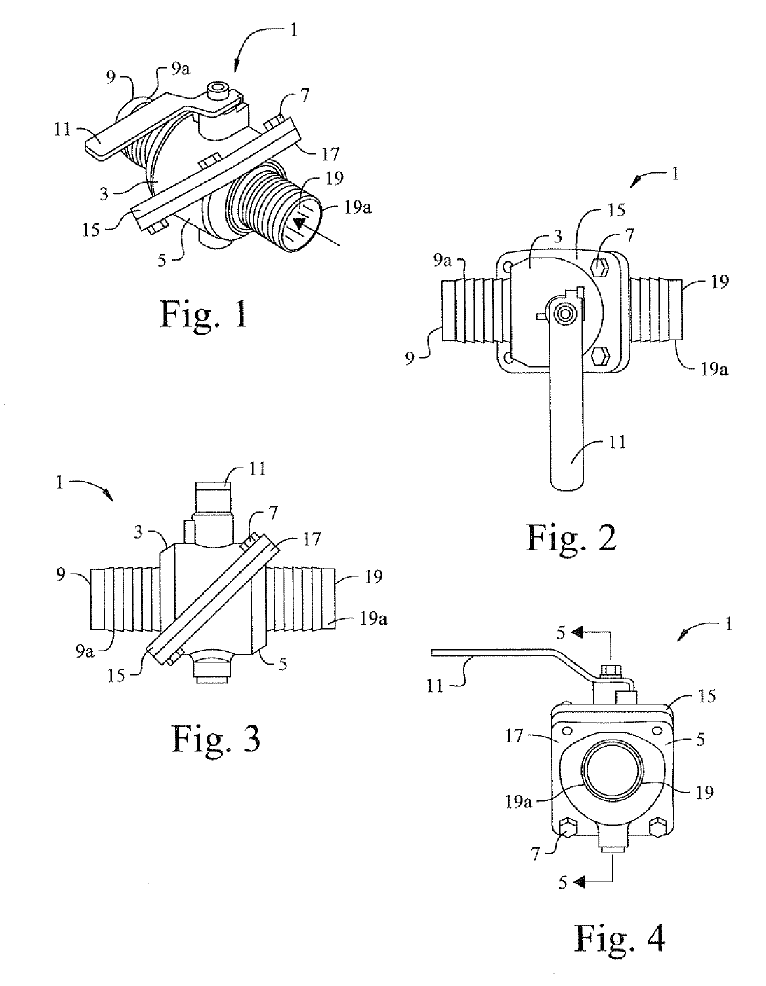

Corresponding reference numerals indicate corresponding parts throughout the several views of the drawings.

### DETAILED DESCRIPTION

Example embodiments will now be described more fully with reference to the accompanying drawings.

The following detailed description illustrates the various embodiments of ball valves by way of example and not by way of limitation. This description will clearly enable one skilled in the art to make and use the disclosed ball valve embodiments, and describes several embodiments, adaptations, variations, alternatives, and uses of the invention, including what we presently believe is the best mode of carrying out the invention.

Referring to the Figures, a half ball valve apparatus 1 for use with a tank trailer or railway car is shown. It should be noted that the ball valve's use with a tanker truck is exemplary only and other uses for the ball valve apparatus 1 may exist as will be appreciated by those skilled in the art. The ball valve apparatus 1 has a valve body having a cavity 25 therein, which is formed from a first half 3 and a second half 5 that are coupled together to form the cavity. An outlet passage 9 and/or hose barb is integrally formed with the first half 3, and an inlet passage 19 and/or hose barb is integrally formed with the second half 5. The inlet 19 and the outlet 9 are in fluid communication with the cavity 25. The first half 3 of the valve body includes a first flange 15 formed at an approximately forty-five degree angle from an outlet passage 9, and the second half 5 of the valve body includes a second flange 17 formed at an approximately forty-five degree angle from the inlet passage 19. The first flange 15 and the second flange 17 are coupled to connect the first half 3 of the valve body and the second half 5 of the valve body. The first half 3 and the second half 5 of the valve body are coupled together using bolts 7 to form the ball valve apparatus 1. It should be noted that bolts 7 are exemplary in nature, and other suitable fasteners or coupling mechanisms may be used to couple the first half 3 and second half 5 of the valve body. In the exemplary embodiment, the first half 3 and second half 5 of the valve body are formed from aluminum; however, as will be appreciated, other suitable materials may be used to form the ball valve body.

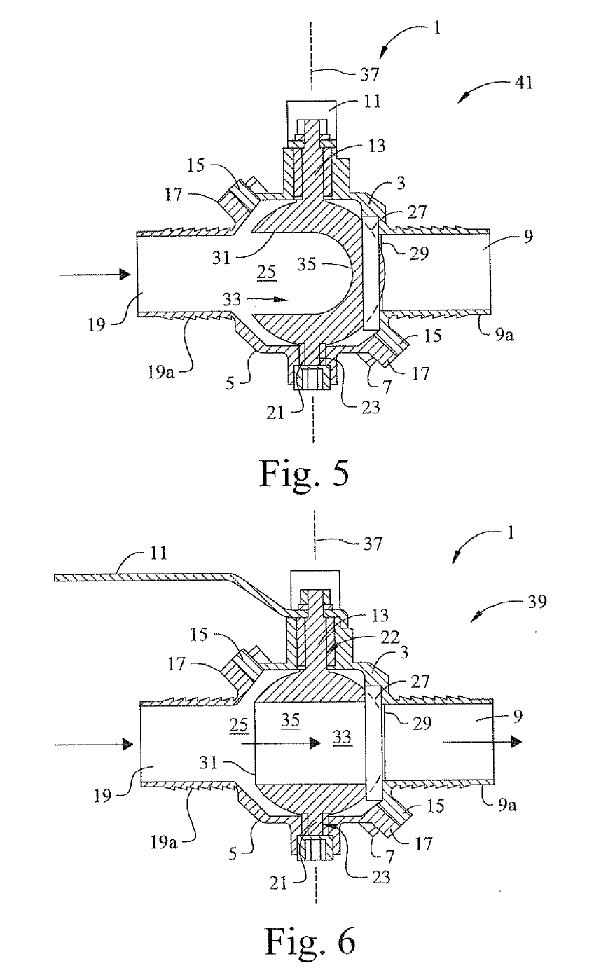

As shown in FIG. 5, the first half 3 of the valve body includes an outlet passage 9, for providing air to the contents of the tanker, for example. In the exemplary embodiment, the outlet passage 9 is a hose barb 9a or a connector, which may be integrally formed with the first half 3 of the valve body. The hose barb 9a is configured to couple to a hose, to discharge the contents of a tanker through the valve, for example. As will be appreciated, hose barb 9a is exemplary only, and the outlet passage 9 may have any suitable form. The first half 3 of the valve body also includes a handle 11 positioned approximately 90 degrees from the outlet passage 9. Handle 11 is coupled to a first upper ball stem 13, which extends through first aperture 22 (in FIG. 6) in the first half 3 of the valve body. In the exemplary embodiment, the handle 11 rotates approximately 90 degrees to rotate a half ball within the cavity between an open and closed position, to control the flow of air through the ball valve apparatus 1. It should be noted that the handle 11 may operate the ball valve apparatus 1 by rotating through any suitable range. A first flange 15 also extends from the first half 3 of the valve body. The first flange 15 is positioned approximately 45 degrees with respect to the outlet passage 9. The first flange 15 preferably positioned at approximately a 45 degree angle so that the first flange 15 mates substantially flush with a second flange 17 of the second half 5 of the valve body. The first flange 15 may be formed integrally with the first half 3 of the valve body, and is configured to couple the first half 3 and second half 5 of the valve body.

The second half 5 of the valve body includes an inlet passage 19, for receiving air to be delivered to the contents of a tanker, for example. In the exemplary embodiment, the inlet passage 19 may be a hose barb 19a, which may be integrally formed with the second half 5. The hose barb 19a may be configured to couple to a hose of a tanker through which air will flow. As will be appreciated, hose barb 19a is exemplary in nature, and inlet passage 19 may take any suitable form. A second lower ball stem 21 extends through second half 5 of the valve body and is positioned in second aperture 23 that is oriented approximately 90 degrees with respect to the inlet passage 19. The second flange 17 extends from the second half 5 and is positioned approximately 45 degrees with respect to the inlet 19. The line of connection between the first half 3 and second half 5 of the valve body is upon a diagonal of approximately 45 degrees, and arranged obliquely with regard to the vertical axis or the ball valve. The second flange 17 may be formed integrally with the second half 5 of the valve body, and is configured to couple with the first flange 15 to couple the first half 3 and the second half 5 of the valve body.

The combination of the apertures 22, 23 in the first half 3 and second half 5, through which the stems coupled to a half ball 31 are inserted during assembly, and the flanges 15, 17 oriented at 45 degrees provide for improved assembly. The first and second halves 3, 5 of the split valve body are specially designed to facilitate the insertion of the coupled ball/stems in to each half, with the upper ball stem 13 passing through the first aperture 22 in the top of the first half 3 of the valve body, and the lower ball stem 21 passing through the second aperture 23 in the bottom of the second half 5 of the valve body.

In the exemplary embodiment, bolts 7 couple the first flange 15 and the second flange 17. Alternatively, the first flange 15 and the second flange 17 may be coupled using any suitable coupling mechanism. When coupled, the handle 11 is positioned opposite the second aperture 23 in the second half 5 of the valve body, and the outlet passage 9 is positioned opposite the inlet passage 19. The ball valve apparatus 1 forms a cavity 25 through which fluid is configured to flow. Specifically, the outlet passage 9, the cavity 25, and the inlet passage 19 are in fluid communication so that fluid flows through the outlet passage 9, through the cavity 25, and through the inlet passage 19.

The cavity 25 includes a single ball seat 27 positioned at an opening 29 of the outlet passage 9 in the first half 3 of the valve body. In the exemplary embodiment, the ball seat 27 is formed from Teflon® however, as will be appreciated by one of ordinary skill in the art, the ball seat 27 may be formed from any other suitable material. A half ball 31 is sealably positioned in the cavity 25 against the ball seat 27, to control the flow through the ball valve apparatus 1. In the exemplary embodiment, the half ball 31 is formed from brass; however, as will be appreciated by one of ordinary skill in the art, the half ball 31 may be formed from any suitable material. Even a half ball made of nylon or a polymer may work as effectively.

The half ball 31 may integrally include the first upper ball stem 13, which extends through the first aperture 22 in the first half 3 of the valve body and couples to the handle 11. The half ball 31 also includes the second lower ball stem 21, which extends through aperture 23 in the second half 5 of the valve body. Both the upper ball stem 13 and the lower ball stem 21 may be formed integrally as one piece with the half ball 31. The half ball 31 further includes a ball-shaped sealing side 35, and a concave recess 33 opposite the sealing side 35, which extends into the half ball 31. In this manner, the first upper ball stem 13 and second lower ball stem 21 provide for accurate control of positioning the half ball 31 against the ball seat 27, as well as rotation of half ball 31 valve relative to ball seat 27.

The half ball 31 rotates approximately 90 degrees within the cavity 25, about an axis 37 formed by the first upper ball stem 13 and the second lower ball stem 21. In alternative embodiments, the half ball 31 may rotate within any suitable range capable of controlling the flow through the ball valve apparatus 1. More specifically, the half ball 31 rotates between an open position 39, as shown in FIG. 6, and a closed position 41, as shown in FIG. 5. In the open position 39, the recess 33 is in fluid communication with both the outlet passage 9 and the inlet passage 19, thereby enabling fluid flow through the ball valve apparatus 1. When the half bail 31 is rotated to the closed position 41, the ball-shaped sealing side 35 of the half ball 31 is sealed against the ball seat 27 to prevent the flow of the fluid or media through the ball valve apparatus 1.

The enclosure of the half ball 31 within the first and second halves 3, 5 results in a loading, or an applied force to the half ball 31 towards the ball seat 27, which provides a sealing force that causes the half ball 31 to be pressed against the ball seat 27 in the closed position. This keeps the half ball 31 biased or loaded against the ball seat 27, to provide for sealing force against the ball seat 27 under varying pressure conditions, such as when an outlet pressure is acting against and forcing the sealing side 35 of the half ball 31 away from the ball seat 27.

With the half ball 31 positioned relative to only a single ball seat 27 (instead of a full ball between two opposing ball seats), the present ball valve apparatus 1 reduces the torque required to rotate the handle 11 and half ball 31 between open and closed positions (relative to two-seat ball valve designs). Furthermore, with the half ball 31 positioned to seal against single ball seat 27, pressure that acts against the recess 33 (opposite the sealing side 35 of the half ball 31) provides a force that is applied to the half ball 31 against the ball seat 27, to improve the sealing function of the half ball 31 relative to the ball seat 27. Thus, the half ball 31 and single ball seat 27 thereby reduce the torque required to rotate the half ball 31 between open and closed positions, while achieving sufficient sealing force to provide an effective seal against the ball seat 27.

Furthermore, conventional ball valves are typically formed from several pieces, such as a valve body with two end plates on each end of the valve body to enclose a bail therein. Such conventional ball valves require two end seals and bolts for securing end plates on opposing ends of the valve body enclosing the ball valve, with the two end seals between the two end plates and the valve body. Accordingly, additional seals are typically required for two end caps, stem openings and other parts. The elimination of additional seals together with the half ball 31 that seals against a single ball seat 27 improves overall sealing function of ball valve apparatus 1 by reducing the number of seals required.

Accordingly, the present disclosure describes embodiments of a ball valve apparatus 1 that is manufactured from fewer parts than known valves. As such, manufacturing time and costs are reduced. Moreover, the strength and durability of the ball valve apparatus 1 is improved, thereby reducing an amount of maintenance associated with worn seals or stressed and cracked parts of the valve.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A ball valve apparatus having:
a first half of a valve body and a second half of a valve body coupled together to form a cavity therein;
the first half of the valve body having an outlet passage, a single ball seat positioned at an opening of the outlet passage, a first aperture through which a first stem is received, and a first flange oriented at approximately 45 degrees from the axis of the outlet passage;
the second half of the valve body having an inlet passage, a second aperture through which a second stem is received, and a second flange oriented at approximately 45 degrees from the axis of the inlet passage;
a half ball coupled to a first stem disposed in the first aperture and coupled to a second stem disposed in the second aperture such that the half ball rotates about an axis of the first stem and second stem, the half ball having a ball-shaped sealing side configured to sealingly engage the single ball seat, and a recessed side opposite a ball-shaped sealing side, the half ball being configured to rotate between a closed position in which the sealing side is sealed against the single ball seat to prevent fluid flow though the ball valve, and an open position in which the recess forms a passage from the inlet to the outlet to permit fluid flow therethrough; and
a handle coupled to the first stem to rotate the half ball between the closed position and open position to control flow through the ball valve.

2. The ball valve apparatus of claim 1, further comprising one or more fasteners for coupling the first flange and the second flange of the first half and second half of the valve body together.

3. The ball valve apparatus of claim 2, wherein the first flange and second flange are oriented at 45 degrees relative to the outlet passage and inlet passage respectively, to permit insertion of the first stem and the second stem, which are coupled to the half ball, within the first and second apertures in the first half and second half of the valve body when the first half and second half of the valve body are coupled together.

4. The ball valve apparatus of claim 3, wherein when the first half and the second half of the valve body are coupled, the half ball is enclosed within the cavity such that the half ball is loaded towards the ball seat to provide a sealing force for causing the sealing surface to be pressed against the ball seat in the closed position.

5. The ball valve apparatus of claim 4, wherein the half ball contacts a single ball seat, such that a reduced torque, relative to a two-seat ball valve design, is required to rotate the handle between the closed and open position.

6. The ball valve apparatus of claim 5, wherein the half ball is configured to rotate approximately ninety degrees between the closed position against the ball seat and the open position forming a passage to the outlet.

7. The ball valve apparatus of claim 3, wherein the half ball is positioned against the single ball seat while in both the first closed position and the second open position.

8. The ball valve apparatus of claim 3, wherein said ball comprises brass and said ball seat comprises Teflon.

9. The ball valve apparatus of claim 3, wherein the first stem and the second stem are integrally formed with the half ball.

10. The ball valve apparatus of claim 3, wherein the one or more fasteners comprises one or more bolts.

11. A ball valve apparatus having:
a first half of a valve body and a second half of a valve body coupled together to form a cavity therein;
the first half of the valve body having an outlet passage, a single ball seat positioned at an opening of the outlet passage, a first aperture through which a first stem is received, and a first flange oriented at approximately 45 degrees from the axis of the outlet passage;
the second half of the valve body having an inlet passage, a second aperture through which a second stem is received, and a second flange oriented at approximately 45 degrees from the axis of the inlet passage;
a half ball that is disposed in the cavity and coupled to a first stem disposed in the first aperture and coupled to a second stem disposed in the second aperture such that the half ball rotates about an axis of the first stem and the second stem, the half ball having a ball-shaped sealing side configured to sealingly engage the single ball seat, and a recessed side opposite a ball-shaped sealing side, the half ball being configured to rotate between a closed position in which the sealing side is sealed against the single ball seat to prevent fluid flow though the ball valve, and an open position in which the recess forms a passage from the inlet to the outlet to permit fluid flow therethrough;
a handle coupled to the first stem to rotate the half ball between the closed position and open position to control flow through the ball valve; and
one or more fasteners for coupling the first flange and the second flange of the first half and second half of the valve body together;
wherein the first flange and second flange are oriented at 45 degrees relative to the outlet passage and inlet passage respectively, to permit insertion of the first stem and the second stem, which are coupled to the half ball, within the first and second apertures in the first half and second half of the valve body when the first half and second half of the valve body are coupled together.

12. The ball valve apparatus of claim 11, wherein when the first half and the second half of the valve body are coupled, the half ball is enclosed within the cavity such that the half ball is loaded towards the ball seat to provide a sealing force for causing the sealing surface to be pressed against the ball seat in the closed position.

13. The ball valve apparatus of claim 12, wherein the half ball contacts a single ball seat, such that a reduced torque, relative to a two-seat ball valve design, is required to rotate the handle between the closed and open position.

14. The ball valve apparatus of claim 13, wherein the half ball is configured to rotate approximately ninety degrees between the closed position against the ball seat and the open position forming a passage to the outlet.

15. The ball valve apparatus of claim 11, wherein the half ball is positioned against the single ball seat while in both the first closed position and the second open position.

16. The ball valve apparatus of claim 11, wherein said ball comprises brass and said ball seat comprises Teflon.

17. The ball valve apparatus of claim 11, wherein the first stem and the second stem are integrally formed with the half ball.

18. The ball valve apparatus of claim 11, wherein the one or more fasteners comprises one or more bolts.

19. A ball valve apparatus having:
a valve body forming a cavity and having an inlet and outlet in fluid communication with the cavity;
a half ball positioned within the cavity that includes a concave recess formed in the half ball to form a fluid passage through the half ball in an open position, to control fluid flow through the cavity,
wherein when the half ball is rotated to a closed position, the half ball seals against a single ball seat at the outlet to prevent the flow of fluid through the cavity, and
when the half ball is rotated to an open position, the recess enables fluid flow through said cavity.

20. The ball valve apparatus of claim 19, wherein the half ball has a ball-shaped sealing side configured to sealingly engage the single ball seat, and a recess on a side opposite a ball-shaped sealing side, the half ball being configured to rotate between a closed position in which the sealing side is sealed against the single ball seat to prevent fluid flow though the ball valve, and an open position in which the recess forms a passage from the inlet to the outlet to permit fluid flow therethrough.
